(19) United States
(12) Patent Application Publication
(10) Pub. No.: US 2016/0286732 A1
(43) Pub. Date: Oct. 6, 2016

(54) PLANT GROWTH CONTROL SYSTEM AND METHOD

(71) Applicant: Xiaomi Inc., Beijing (CN)

(72) Inventors: Ke WU, Beijing (CN); Xinyu LIU, Beijing (CN)

(73) Assignee: Xiaomi Inc.

(21) Appl. No.: 15/083,222

(22) Filed: Mar. 28, 2016

(30) Foreign Application Priority Data
Mar. 31, 2015 (CN) 201510145989.X

(51) Int. Cl. A01G 7/04; F21V 23/04; G05B 15/02; F21V 23/00; A01G 9/20; A01G 1/00

(52) U.S. Cl. CPC A01G 7/045; A01G 9/20; A01G 1/001; G05B 15/02; F21V 23/003; F21V 23/0471

(57) ABSTRACT

A plant growth control system is disclosed. The plant growth control system includes: an information collection device, a processor coupled to the information collection device, and a controllable light source. The information collection device is configured to acquire growth information of a plant, the growth information including at least one of branch and leaf distribution information of the plant or flower distribution information of the plant. The processor is configured to determine, according to the growth information, a target irradiation position of the plant for the controllable light source to irradiate, and control the controllable light source to irradiate the target irradiation position of the plant.

### CROSS-REFERENCE TO RELATED APPLICATIONS

This application is based upon and claims priority to Chinese Patent Application No. CN201510145989.X, filed on Mar. 31, 2015, the entire contents of which are incorporated herein by reference.

### TECHNICAL FIELD

The present disclosure relates to the field of control systems and, more particularly, to a plant growth control system and method.

### BACKGROUND

As living standard of people improves, more and more users start cultivating plants at homes or in offices. Because a plant generally grows facing the sun, after a period of time, the side of the plant facing the sun may grow more densely than the side not facing the sun, due to more light on the side facing the sun.

To enable the plant to receive relatively uniform light irradiation and to help the plant grow better, the user needs to rotate the plant pot where the plant grows to a certain direction from time to time. For example, the user rotates the plant pot by 180 degrees every week.

### SUMMARY

According to a first aspect of the present disclosure, there is provided a plant growth control system. The plant growth control system includes: an information collection device, a processor coupled to the information collection device, and a controllable light source. The information collection device is configured to acquire growth information of a plant, the growth information including at least one of branch and leaf distribution information of the plant or flower distribution information of the plant. The processor is configured to determine, according to the growth information, a target irradiation position of the plant for the controllable light source to irradiate, and control the controllable light source to irradiate the target irradiation position of the plant.

According to another aspect of the present disclosure, there is provided a plant growth control method. The method is performed in a plant growth control system which comprises an information collection device, a processor coupled to the information collection device, and a controllable light source. The method includes: acquiring growth information of a plant, the growth information including at least one of branch and leaf distribution information of the plant or flower distribution information of the plant; determining, according to the growth information, a target irradiation position of the plant; and controlling the controllable light source to irradiate the target irradiation position of the plant.

It shall be appreciated that the above general description and the detailed description hereinafter are only illustrative but not for limiting the present disclosure.

### BRIEF DESCRIPTION OF THE DRAWINGS

The accompanying drawings herein, which are incorporated into and constitute a part of the specification, illustrate embodiments consistent with the present disclosure, and together with the specification, serve to explain the principles of the present disclosure.

FIG. 1 is a schematic diagram illustrating a plant growth control system, according to an example embodiment of the present disclosure.

FIG. 2A is a schematic diagram illustrating a plant growth control system, according to another example embodiment of the present disclosure.

FIG. 2B is a schematic diagram illustrating positions where light intensity sensors are arranged on a flower pot, according to another example embodiment of the present disclosure.

FIG. 3A is a schematic diagram illustrating a plant growth control system, according to still another example embodiment of the present disclosure.

FIG. 3B is a schematic diagram showing a controllable light source and a target irradiation position, according to still another example embodiment of the present disclosure.

FIG. 3C is a schematic diagram illustrating a plant growth control system, according to yet still another example embodiment of the present disclosure.

FIG. 4 is a flowchart illustrating a plant growth control method, according to an example embodiment of the present disclosure.

FIG. 5 is a flowchart illustrating a plant growth control method, according to another example embodiment of the present disclosure.

FIG. 6 is a flowchart illustrating a plant growth control method, according to still another example embodiment of the present disclosure.

FIG. 7 is a flowchart illustrating a plant growth control method, according to yet still another example embodiment of the present disclosure.

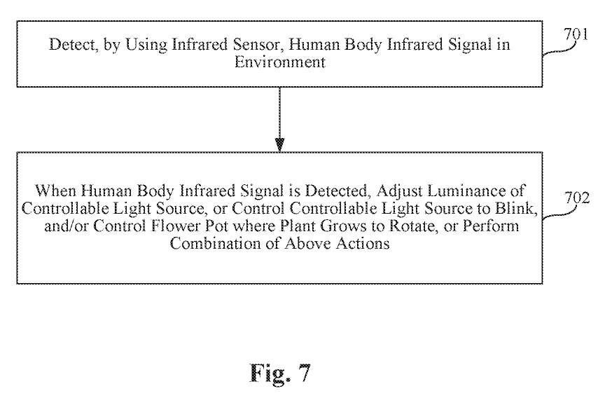

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the present disclosure. Instead, they are merely examples of systems and methods consistent with aspects related to the present disclosure as recited in the appended claims.

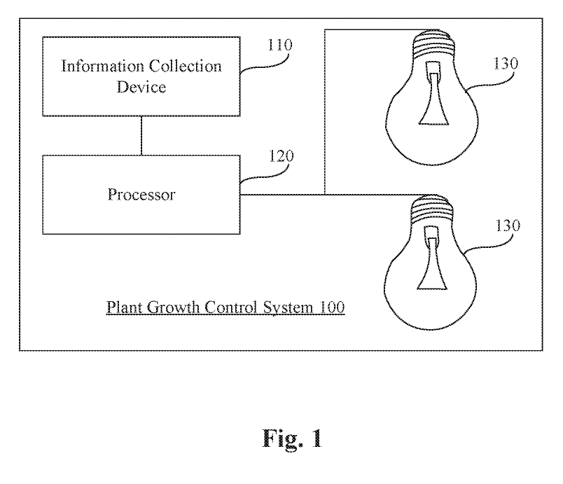

FIG. 1 is a schematic diagram illustrating a plant growth control system 100 according to an example embodiment of the present disclosure. The plant growth control system 100 may include: an information collection device 110, a processor 120 coupled to the information collection device 110, and at least one controllable light source 130.

The information collection device 110 is configured to acquire growth information of a plant. The growth information includes at least one of branch and leaf distribution information or flower distribution information of the plant.

The processor 120 is configured to determine, according to the growth information, a target irradiation position of the plant for the controllable light source 130 to irradiate, and control the controllable light source 130 to irradiate the target irradiation position of the plant. The controllable light source 130 may be a light source which may change an actual irradiation position of the plant. For example, the irradiation direction of the controllable light source 130 is rotatable or the position of the controllable light source 130 is movable, or the plant is rotatable relative to the position of the controllable light source 130.

The processor 120 may be coupled to the controllable light source 130. In some embodiments, the controllable light source 130 may be a lamp, and the irradiation direction of the lamp is changed under the control of the processor 120. In some embodiments, the controllable light source 130 may also be a light source including a mechanical part and a lamp coupled to the mechanical part. The position of the mechanical part is changed under the control of the processor 120, so as to change the position of the lamp. The mechanical part may be a mechanical arm, a circular guide rail, a magnetic suspension chassis, or the like, which is not limited in the present disclosure. In addition, by way of example, the controllable light source 130 is a lamp in FIG. 1.

Thus, the plant growth control system 100 provided by the embodiments of the present disclosure may acquire growth information of a plant. A target irradiation position of the plant for the controllable light source to irradiate is determined according to the growth information, and the controllable light source is controlled to irradiate the target irradiation position of the plant. The plant growth control system 100 solves the problem in the related art that a user needs to rotate the flower pot where the plant grows from time to time, and can automatically control the controllable light source 130 to irradiate a portion of the plant that needs light irradiation, thereby reducing user's actions.

In some embodiments, a plant growth control system may collect relevant information by using a light intensity sensor or a camera to acquire growth information of a plant. That is, the information collection device 110 may include a light intensity sensor or a camera. Plant growth control systems having a light intensity sensor or a camera are described in different embodiments below.

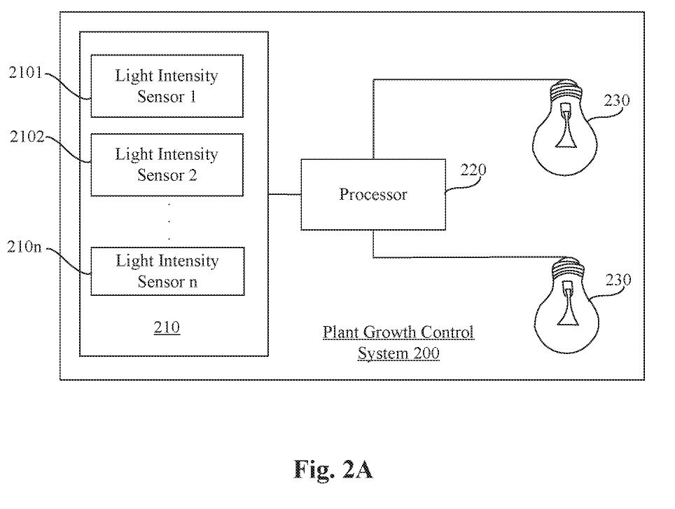

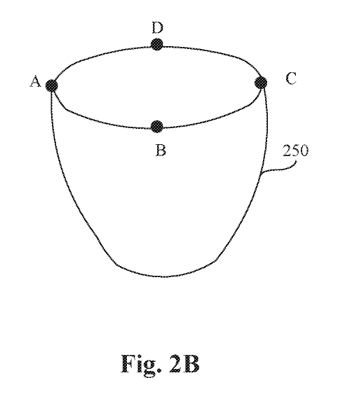

FIG. 2A is a schematic diagram illustrating a plant growth control system 200 according to another example embodiment of the present disclosure. The system 200 described in this embodiment uses an information collection device equipped with at least two light intensity sensors as an example. As illustrated in FIG. 2A, the plant growth control system 200 may include: an information collection device 210, a processor 220 coupled to the information collection device 210, and at least one controllable light source 230.

The information collection device 210 is configured to acquire growth information of a plant. The growth information includes at least one of branch and leaf distribution information or flower distribution information of the plant.

The processor 220 is configured to determine, according to the growth information, a target irradiation position of the plant for the controllable light source 230 to irradiate, and control the controllable light source 230 to irradiate the target irradiation position of the plant. The controllable light source 230 may be a light source which may change an actual irradiation position of the plant. For example, the irradiation direction of the controllable light source 230 is rotatable, or the controllable light source 230 is movable, or the plant is rotatable relative to the position of the controllable light source 230. The processor 220 may be coupled to the controllable light source 230. In some embodiments, the controllable light source 230 may be a lamp, and the irradiation direction of the lamp is changed under the control of the processor 220. In some embodiments, the controllable light source 230 may also be a light source including a mechanical part and a lamp coupled to the mechanical part. The position of the mechanical part is changed under the control of the processor 220, so as to change the position of the lamp. The mechanical part may be a mechanical arm, a circular guide rail, a magnetic suspension chassis, or the like, which is not limited in this embodiment.

In some embodiments, the processor 220 may determine the target irradiation position in the following manners. When the growth information includes the branch and leaf distribution information and it is desired that the plant grows more uniformly, the processor 220 may determine a side of the plant where a sparse degree of the branch and leaf distribution is less than a first threshold, as the target irradiation position. The growth on the side of the plant is promoted by giving more light irradiation to the side. If it is desired that the plant receives more uniform light irradiation, to enable a side of the plant where the branches and leaves are relatively dense to also receive light irradiation, the processor 220 may determine a side of the plant where a sparse degree of the branch and leaf distribution is greater than a second threshold as the target irradiation position.

When the growth information includes the flower distribution information and it is desired to enable the blooming flowers to receive sufficient light irradiation to ensure better blooming of the flowers, the processor 220 may determine a position of the plant where the flowers are blooming as the target irradiation position. If it is desired to enable a no-flower side of the plant to more quickly bloom, the processor 220 may determine a position of the plant where the flowers are not ready to bloom as the target irradiation position. The above description provides examples how the processor 220 determines the target irradiation position. The present disclosure is not limited to these examples. The processor 220 may also determine the target irradiation position in other manners.

The information collection device 210 may include a plurality of light intensity sensors 2101, 2102, . . . 210n. Each of the light intensity sensors 2101, 2102, . . . 210n is configured to acquire a light intensity yielded after the ambient light penetrates through the plant. At least two light intensity sensors are generally arranged at the bottom of the plant. As such, when the ambient light penetrates through the plant and reaches the light intensity sensors 2101, 2102, . . . 210n arranged at the bottom of the plant, the light intensity sensors 2101, 2102, . . . 210n may respectively acquire the light intensities. To acquire branch, leaf, or flower distribution information of the plant in various directions, the light intensity sensors 2101, 2102, . . . 210n may be evenly arranged around the root portion of the plant. In addition, each of the light intensity sensors 2101, 2102, . . . 210n may always be in a working state. To prolong the service life of the light intensity sensors 2101, 2102, . . . 210n, the plant growth control system 200 may further include switches for controlling the light intensity sensors 2101, 2102, . . . 210n. When the growth of the plant needs to be controlled, the switches are turned on and the light intensity sensors are set to the working state.

After each of the light intensity sensors 2101, 2102, . . . 210n acquires its corresponding light intensity, the processor 220 may correspondingly determine the growth information of the plant according to the light intensities acquired by the light intensity sensors 2101, 2102, . . . 210n. In some embodiments, the sparser a side of the plant is, the greater the light intensity yielded after the ambient light penetrates through the side of the plant is; and the denser a side of the plant is, the less the light intensity yielded after the ambient light penetrates through the side of the plant is. After the processor 220 obtains the light intensities, the processor 220 may determine the side corresponding to a light intensity sensor which collects a relatively weak light intensity in the plant as a dense side, and determine the side corresponding to a light intensity sensor which collects a relatively strong light intensity in the plant as a sparse side. That is, the processor 220 may determine the branch and leaf distribution information of the plant based on the information collected by light intensity sensors 2101, 2102, . . . 210n. The number of light intensity sensors is not limited. If more light intensity sensors are provided in the plant growth control system 200, the determined distribution information of the plant may be more accurate. Therefore, the number of light intensity sensors may be determined according to actual needs of accuracy.

In some embodiments, the plant growth control system 200 may further include a flower pot, and at least two light intensity sensors may be arranged on the top edge of the flower pot.

The light intensity sensors may be evenly arranged on the top edge of the flower pot. For example, a flower pot 250 having four light intensity sensors is shown in FIG. 2B. The top edge of the flower pot 250 is evenly divided into four regions, and each of the four light intensity sensors is disposed in one of the four regions in the flower pot, for example, at four positions A, B, C and D as illustrated in FIG. 2B. In some embodiments, each of the light intensity sensors may be integrated into the flower pot 250. In other embodiments, the flower pot 250 and the light intensity sensors may be two independent parts. A user may install the light intensity sensors on the edge of the flower pot 250. The configurations of the flower pot 250 and the light intensity sensors are not limited in the present disclosure.

In some embodiments, in order to control the controllable light source 230 to irradiate the target irradiation position of the plant, the controllable light source 230 in the plant growth control system 200 may be in a moving state or a stationary state under the control of the processor 220. For example, after the processor 220 determines a target irradiation position, the processor 220 may control the controllable light source 230 to move a suitable position to irradiate the target irradiation position of the plant.

In one embodiment, the controllable light source 230 may be controlled to rotate. For example, the controllable light source 230 may be a rotatable lamp (similar to a swing camera). The processor 220 may control the rotation of the lamp to thus rotate the lamp to a desired position. Alternatively, the processor 220 may control the controllable light source 230 to move laterally and/or vertically. For example, the controllable light source 230 may be a suspension lamp, and the suspension lamp may change its suspension position under the control of the processor 220. The movement of the controllable light source 230 of the present disclosure is not particularly limited.

In some embodiments, the controllable light source 230 may include a lamp or a lamp seat. The lamp seat is used for mounting a light bulb. The lamp may be a suspension lamp, a ceiling lamp, or a table lamp. The light of the lamp may be in red, white, yellow, green or any other color. In addition, when the lamp is a suspension lamp, the plant growth control system 200 may further include a suspension system corresponding to the suspension lamp, which may include a system located at the lower or upper part of the suspension lamp, or at both lower and upper parts of the suspicion lamp. The processor 220 may move the suspension lamp by controlling the suspension system. In addition, the number of controllable light sources 230 may be one, or two, or more. When there are two or more controllable light sources 230, the processor 220 may selectively control one or a plurality of the controllable light sources 230 to irradiate the target irradiation position of the plant. In some embodiments, the plurality of controllable light sources 230 may have the same color or different colors, which is not limited in the present disclosure.

In some embodiments, when the processor 220 controls the controllable light source 230 to be in a moving state or a stationary state, the process that the processor 220 controls the controllable light source 230 to irradiate the target irradiation position of the plant may be implemented in any one of the following two manners.

In the first manner, the controllable light source in an ON state is controlled to rotate. Rotation of the controllable light source is stopped when the light intensity sensor corresponding to the target irradiation position acquires a light intensity greater than a predetermined light intensity.

When the controllable light source 230 is a rotatable light source, the processor 220 may control the controllable light source 230 in the ON state to rotate. In the illustrated embodiment, each of the light intensity sensors collects a light intensity in real time. When the light intensity acquired by the light intensity sensor corresponding to the target irradiation position is greater than a predetermined light intensity, it can be determined that the controllable light source 230 moves approximately to the target irradiation position. In this case, the processor 220 may control the controllable light source 230 to stop rotating.

The light intensity sensor corresponding to the target irradiation position is the light intensity sensor based on which the target irradiation position is determined. For example, the processor 220 determines a side of the plant where a sparse degree of the branch and leaf distribution is less than a first threshold as the target irradiation position. Also for example, the side is determined when the light intensity sensor at the location acquires the greatest light intensity among all of the light intensity sensors. The light intensity sensor corresponding to the target irradiation position is the light intensity sensor which acquires the highest light intensity.

In the second manner, the controllable light source in an ON state is controlled to move. Movement of the controllable light source is stopped when the light intensity sensor corresponding to the target irradiation position acquires a light intensity greater than a predetermined light intensity.

When the controllable light source 230 is a movable light source, the processor 220 may control the controllable light source 230 in the ON state to move. When the light intensity acquired by the light intensity sensor corresponding to the target irradiation position is greater than a predetermined light intensity, it can be determined that the controllable light source 230 moves approximately to the target irradiation position. In this case, the processor 220 may control the controllable light source 230 to stop moving.

The light intensity sensor corresponding to the target irradiation position is the light intensity sensor based on which the target irradiation position is determined.

In the illustrated embodiment, when the light intensity acquired by the light intensity sensor corresponding to the target irradiation position is greater than a predetermined light intensity, the processor stops the movement of the controllable light source. In some embodiments, the processor may also stop movement of the controllable light source when the light intensity sensor corresponding to the target irradiation position acquires a light intensity greater than the highest light intensity the light intensity sensor previously acquired. The method of controlling the controllable light source is not so limited in the present disclosure. In addition, if the initial state of the controllable light source 230 is an OFF state, the processor 220 needs to turn on the controllable light source 230 before moving the same.

In some embodiments, the plant growth control system 200 may further include a base for accommodating the flower pot. The base may be electrically connected to the processor 220, and controlled to be in a rotation state or a stationary state by the processor 220. When the base rotates, the flower pot disposed on the base may correspondingly rotate. For example, after the processor 220 determines the target irradiation position, the processor 220 may control the base to rotate to thus drive the flower pot to rotate. As such, the target irradiation position of the plant in the flower pot is moved to under the light source.

In some embodiments, when the base is controlled to be in a rotation state or a stationary state by the processor 220, the process that the processor 220 controls the controllable light source 230 to irradiate the target irradiation position of the plant may be implemented in the following manners.

The processor 220 controls the rotation of the flower pot where the plant grows, and stops the rotation of the flower pot when the light intensity sensor corresponding to the target irradiation position acquires a light intensity greater than a predetermined light intensity. The processor 220 may control the base to rotate. The rotation of the base may drive the flower pot thereon to rotate as well. That is, the plant in the flower pot may also be rotated. When the light intensity acquired by the light intensity sensor corresponding to the target irradiation position is greater than a predetermined light intensity, it can be determined that the target irradiation position of the plant is moved to substantially under the light source. In this case, the processor 220 may stop rotating the base to stop rotating the flower pot.

In the illustrated embodiments, the controllable light source 230 may be in a moving state or a stationary state under the control of the processor 220, or the base may be in a rotation state or a stationary state under the control of the processor 220. In some embodiments, the controllable light source 230 and the base may both be moved or rotated under the control of the processor 220, which is not particularly limited in the present disclosure.

In some embodiments, the plant growth control system 200 in the present disclosure may be a battery-powered system or a system connected to a power socket to receive power. In one embodiment, when the system 200 is connected to a power socket to receive power, the system 200 may further include a connection wire and a plug for connecting the socket. In another embodiment, when the light source is a suspension lamp, the suspension lamp may also be a wirelessly-chargeable lamp.

Thus, the plant growth control system 200 provided by the embodiments of the present disclosure may acquire growth information of a plant. A target irradiation position of the plant for the controllable light source to irradiate is determined according to the growth information, and the controllable light source is controlled to irradiate the target irradiation position of the plant. The plant growth control system 200 solves the problem in the related art that a user needs to rotate the flower pot where the plant grows from time to time; and can automatically control the controllable light source 230 to irradiate a portion of the plant that needs light irradiation, thereby reducing user's actions.

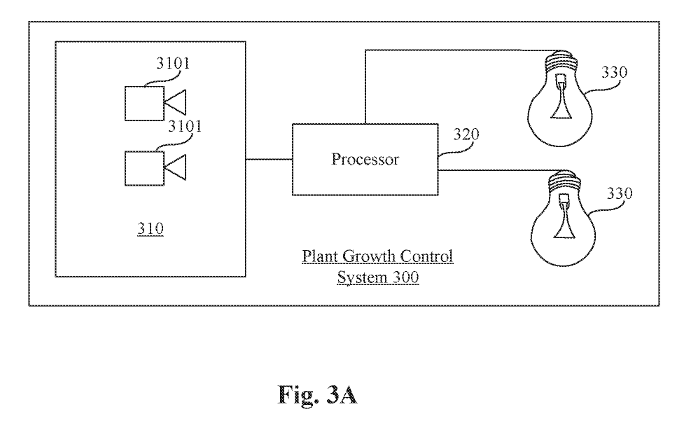

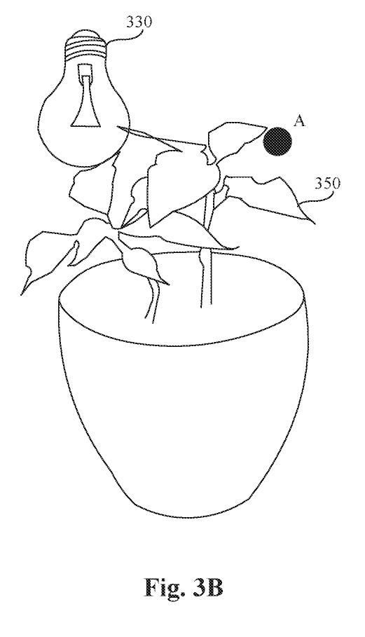

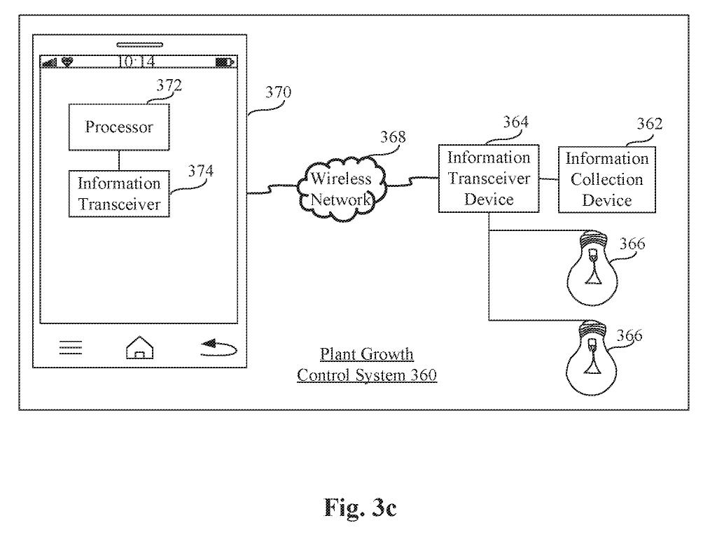

FIG. 3A is a schematic diagram illustrating a plant growth control system 300, according to still another example embodiment of the present disclosure. As illustrated in FIG. 3A, the plant growth control system 300 includes an information collection device 310 equipped with at least one camera 3101, a processor 320 coupled to the information collection device 310, and at least one controllable light source 330.

The information collection device 310 is configured to acquire growth information of a plant. The growth information includes at least one of branch and leaf distribution information or flower distribution information of the plant.

The processor 320 is configured to determine, according to the growth information, a target irradiation position of the plant for the controllable light source 330 to irradiate, and control the controllable light source 330 to irradiate the target irradiation position of the plant. The controllable light source 330 is a light source which may change an actual irradiation position of the plant. For example, the irradiation direction of the controllable light source 330 is rotatable or the position of the controllable light source 330 is movable. The relevant features of the controllable light source 330 are similar to those of the controllable light source 130 and 230 described in the above embodiments, which are not repeated herein.

In some embodiments, the processor 320 may determine the target irradiation position in the following manners. When the growth information includes the branch and leaf distribution information, and it is desired that the plant grows more uniformly, the processor 320 may determine a side of the plant where a sparse degree of the branch and leaf distribution is less than a first threshold, as the target irradiation position such that the growth on the side of the plant is promoted by giving more light irradiation to the side. If it is desired that the plant receives more uniform light irradiation, to enable a side where the branches and leaves are relatively dense to also receive light irradiation, the processor 320 may determine a side of the plant where a sparse degree of the branch and leaf distribution is greater than a second threshold, as the target irradiation position.

When the growth information includes the flower distribution information, and it is desired to enable the blooming flowers to receive sufficient light irradiation to ensure better blooming of the flowers, the processor 320 may determine a position of the plant where the flowers are blooming as the target irradiation position. If it is desired to enable a no-flower side of the plant to quickly bloom, the processor 320 may determine the position of the plant where the flowers are not ready to bloom as the target irradiation position. The above description provides examples how the processor 320 determines the target irradiation position. The present disclosure is not limited to these examples. The processor 320 may also determine the target irradiation position in other manners.

Referring to FIG. 3A, the information collection device 310 may include at least one camera 3101. The camera 3101 is configured to acquire an image containing the plant. In some embodiments, the information collection device 310 may include two or more cameras 3101. When the information collection device 310 includes one camera 3101, the camera 3101 may be disposed higher than the plant. As such, the camera 3101 may acquire a full-view image containing the plant. In some embodiments, the position of the camera 3101 may also be as high as the plant. In this case, the flower pot where the plant grows may be constantly rotated such that the camera 3101 acquires a plurality of frames of images containing the plant. In some embodiments, when there are a plurality of cameras 3101, the plurality of cameras 3101 may acquire images containing the plant from different angles and points of view.

After the camera 3101 acquires the image containing the plant, the processor 320 may acquire the growth information of the plant according to the image. In some embodiments, the processor 320 may analyze the acquired image, obtain analysis result about the branch and leaf distribution, blooming flower distribution or both, and use the obtained analysis result as the growth information of the plant.

In some embodiments, to control the controllable light source 330 to irradiate the target irradiation position of the plant, the processor 320 may control the controllable light source 330 in the plant growth control system to be in a moving state or a stationary state.

When the processor 320 controls the controllable light source 330 to be in a moving state or a stationary state, the process that the processor 320 controls the controllable light source 330 to irradiate the target irradiation position of the plant may be implemented in the following manners:

First, positions of the controllable light source 330 and the target irradiation position relative to each other are determined according to the image acquired by the camera 3101.

To acquire the position of the controllable light source 330, the image containing the plant acquired by the camera 3101 in this embodiment needs to include the controllable light source 330. In this way, the processor 320 may analyze the image containing both the plant and the controllable light source 330 to obtain positions of the controllable light source 330 and the target irradiation position of the plant relative to each other.

Second, a desirable light-irradiating angle of the controllable light source is determined according to the relative positions.

The plant growth control system 300 may pre-store several candidate light-irradiating angles, for example, at 90 degrees, 180 degrees and 270 degrees clockwise from a predetermined original point. After determining the relative positions, the processor 320 selects a light-irradiating angle closest to a target angle from all the candidate light-irradiating angles. The target angle is an angle by which the current position of the light source is adjusted to the target irradiation position. FIG. 3B is an exemplary image acquired by a camera, showing the controllable light source 330 and a plant 350. Based on the image, the processor 320 may determine, for example, that the controllable light source 330 needs to be adjusted by 90 degrees clockwise according to the relative positions of the controllable light source 330 and the target irradiation position (position A in FIG. 3B).

In some embodiments, the processor 320 may calculate, according to the relative positions, the adjustment angle by which the controllable light source 330 is adjusted to the target irradiation position, and control the controllable light source 330 to rotate by the calculated adjustment angle.

Third, the light-irradiating angle of the controllable light source 330 is adjusted according to the adjustment angle.

After determining the adjustment angle, the processor 320 may rotate the controllable light source 330 by the determined adjustment angle, for example, 90 degrees clockwise.

In some embodiments, the plant growth control system 300 may further include a base for accommodating the flower pot. The base may be electrically connected to the processor 320, and controlled to be in a rotation state or a stationary state by the processor 320. When the base rotates, the flower pot disposed on the base may correspondingly rotate.

In some embodiments, when the base is controlled to be in a rotation state or a stationary state by the processor 320, the process that the processor 320 controls the controllable light source 330 to irradiate the target irradiation position of the plant may be implemented in the following manners.

First, positions of the controllable light source and the target irradiation position relative to each other are determined according to an image acquired by a camera.

Second, an adjustment angle desired for the flower pot where the plant grows is determined according to the relative positions. The details of obtaining the adjustment angle are explained above and not repeated here.

Third, the flower pot is adjusted according to the adjustment angle by rotating the base.

In some embodiments, the controllable light source 330 is controlled to be in a moving state or a stationary state by the processor 320, or the base is controlled to be in a rotation state or a stationary state by the processor 320. In some embodiments, the controllable light source 330 and the base may both be moved or rotates under the control of the processor 320.

In some embodiments, the plant growth control system 300 in the present disclosure may be a battery-powered system or a system connected to a power socket to receive power. In one embodiment, when the system 300 is connected to a power socket to receive power, the system 300 may further include a connection wire and a plug for connecting the socket. In another embodiment, when the light source is a suspension lamp, the suspension lamp may also be a wirelessly-chargeable lamp.

Thus, the plant growth control system 300 provided by the embodiments of the present disclosure may acquire growth information of a plant. A target irradiation position of the plant for the controllable light source to irradiate is determined according to the growth information, and the controllable light source is controlled to irradiate the target irradiation position of the plant. The plant growth control system 300 solves the problem in the related art that a user needs to rotate the flower pot where the plant grows from time to time; and can automatically control the controllable light source 330 to irradiate a portion of the plant that needs light irradiation, thereby reducing user's actions.

In some embodiments, the plant growth control system may further include an infrared sensor, electrically connected to the processor. The infrared sensor is configured to detect a human body infrared signal in an environment.

Correspondingly, the processor of the system is further configured to, when the infrared sensor detects a human body infrared signal, control irradiation of the controllable light source and/or the rotation of the flower pot where the plant grows. For example, the luminance of the controllable light source may be adjusted or the controllable light source is controlled to blink when the infrared sensor detects a human body infrared signal.

When a person approaches a plant, the human body infrared sensor in the plant growth control system may detect a human body infrared signal. At this time, the processor may increase the luminance of the light source, or control the light source to blink, or control the base of the flower pot to rotate, which brings a particular visual experience to a user, and improves the user experience. In some embodiments, the controllable light source includes a plurality of light sources having different colors of light, to create a dazzling visual experience to the user.

In some embodiments, the controllable light source includes a plurality of magnetic suspension lamps having different colors of light. Each magnetic suspension lamp may move or rotate under the control of the processor. As such, when the infrared sensor detects a human body infrared signal, these magnetic suspension lamps may be rotated under control of the processor, to create a visual experience for the user.

In some embodiments, the processor in the plant growth control system in the above embodiments may be a processor in a smart terminal. FIG. 3C is a schematic diagram showing an exemplary plant growth control system 360 according to one embodiment of the present disclosure. The system 360 includes an information collection device 362, an information transceiver device 364, at least one controllable light source 366, a wireless network 368, and a mobile terminal 370 including a processor 372 and an information transceiver 374. The processor 372 may receive a control instruction from a user, and perform a corresponding operation according to the received control instruction. The control instruction is used to control the controllable light source 366 to move or rotate, or control the flower pot or base to rotate. In some embodiments, when the control instruction is used to control the controllable light source 366 to move, the processor 372 may establish a wireless connection with the information transceiver device 364 coupled to the controllable light source 366 via an information transceiver 374 in the mobile terminal 370. The processor 372 is configured to send the control instruction to the controllable light source 366 via the established wireless connection, to control the controllable light source 366. A user thus may remotely control growth of the plant by using his or her mobile terminal, thereby improving the user experience.

In some embodiments, the processor 372 may also be wirelessly connected to the information collection device 362 by using the information transceiver 374 in the mobile terminal 370, receive the information collected by the information collection device 362, and process the received information.

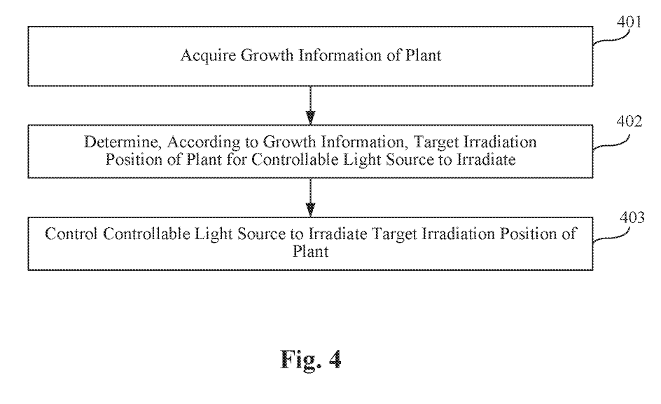

FIG. 4 is a flowchart illustrating a plant growth control method 400, according to an example embodiment of the present disclosure. The plant growth control method 400 may be performed by the plant growth control system 100 as illustrated in FIG. 1. Referring to FIG. 4, the plant growth control method 400 may include the following steps.

In step 401, growth information of a plant is acquired. The growth information includes at least one of branch and leaf distribution information and flower distribution information of the plant.

In step 402, a target irradiation position of the plant for a controllable light source to irradiate is determined according to the growth information.

In step 403, the controllable light source is controlled to irradiate the target irradiation position of the plant.

Thus, according to the plant growth control method 400 provided by the embodiments of the present disclosure, growth information of a plant is acquired. A target irradiation position of the plant for a controllable light source to irradiate is determined according to the growth information. The controllable light source is controlled to irradiate the target irradiation position of the plant. The plant growth control method 400 solves the problem in the related art that a user needs to rotate the flower pot where the plant grows from time to time; and can automatically control the controllable light source to irradiate a portion of the plant that needs light irradiation, thereby reducing user's actions.

As explained above, the plant growth control system may collect relevant information by using a light intensity sensor or a camera to acquire growth information of a plant. The plant growth control methods in which plant growth information is collected by light intensity sensors and a camera are described in different embodiments below.

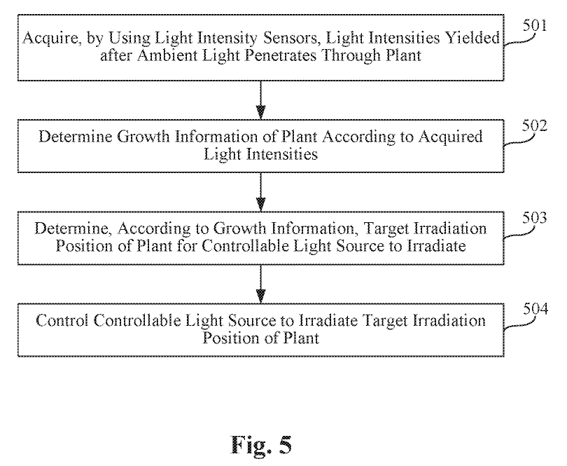

FIG. 5 is a flowchart illustrating a plant growth control method 500 according to an example embodiment of the present disclosure. The plant growth control method 500 may be performed by the plant growth control system 200 as illustrated in FIG. 2A. Referring to FIG. 5, the plant growth control method 500 may include the following steps.

In step 501, light intensities yielded after ambient light penetrates through the plant are respectively acquired by using at least two light intensity sensors. The light intensity sensors may be arranged at the bottom of the plant.

In step 502, the growth information of the plant is determined according to the acquired light intensities.

The growth information includes at least one of branch and leaf distribution information or flower distribution information of the plant.

In step 503, a target irradiation position of the plant for a controllable light source to irradiate is determined according to the growth information.

In some embodiments, step 503 may include: when the growth information includes the branch and leaf distribution information, determining a side of the plant where a sparse degree of the branch and leaf distribution is less than a first threshold as the target irradiation position, or determining a side of the plant where a sparse degree of the branch and leaf distribution is greater than a second threshold as the target irradiation position; and when the growth information includes the flower distribution information, determining a side of the plant where flowers are blooming as the target irradiation position.

In step 504, the controllable light source is controlled to irradiate the target irradiation position of the plant.

In some embodiments, step 504 may be implemented by one or more of the following exemplary methods.

First, the controllable light source in an ON state is controlled to rotate and stop rotating when the light intensity sensor corresponding to the target irradiation position acquires a light intensity greater than a predetermined light intensity.

Second, the controllable light source in an ON state is controlled to move and stop moving when the light intensity sensor corresponding to the target irradiation position acquires a light intensity greater than a predetermined light intensity.

Third, the flower pot where the plant grows is controlled to rotate and stop rotating when the light intensity sensor corresponding to the target irradiation position acquires a light intensity greater than a predetermined light intensity.

Thus, according to the plant growth control method 500 provided by the embodiments of the present disclosure, growth information of a plant is acquired. A target irradiation position of the plant for a controllable light source to irradiate is determined according to the growth information. The controllable light source is controlled to irradiate the target irradiation position of the plant. The plant growth control method 500 solves the problem in the related art that a user needs to rotate the flower pot where the plant grows from time to time; and can automatically control the controllable light source to irradiate a portion of the plant that needs light irradiation, thereby reducing user's actions.

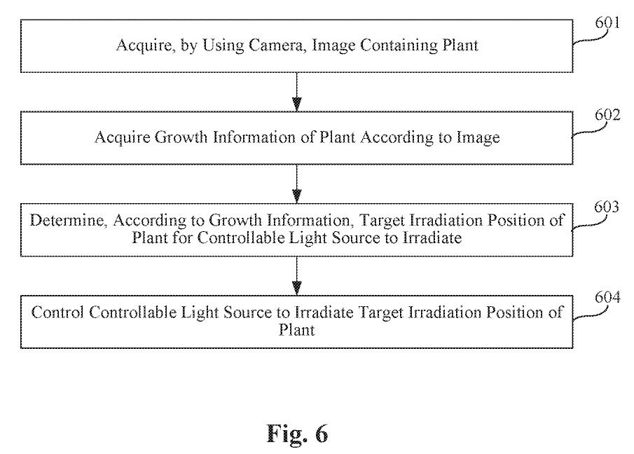

FIG. 6 is a flowchart illustrating a plant growth control method 600 according to an example embodiment of the present disclosure. The plant growth control method 600 may be performed by the plant growth control system 300 as illustrated in FIG. 3A. Referring to FIG. 6, the plant growth control method 600 may include the following steps.

In step 601, an image containing the plant is acquired by using a camera.

In step 602, the growth information of the plant is acquired according to the image.

The growth information includes at least one of branch and leaf distribution information or flower distribution information of the plant.

In step 603, a target irradiation position of the plant for a controllable light source to irradiate is determined according to the growth information.

When the growth information includes the branch and leaf distribution information, a side of the plant where a sparse degree of the branch and leaf distribution is less than a first threshold is determined as the target irradiation position, or a side of the plant where a sparse degree of the branch and leaf distribution is greater than a second threshold is determined as the target irradiation position.

When the growth information includes the flower distribution information, a side of the plant where flowers are blooming is determined as the target irradiation position.

In step 604, the controllable light source is controlled to irradiate the target irradiation position of the plant.

In some embodiments, step 604 may include: determining positions of the controllable light source and the target irradiation position relative to each other according to the image; determining, according to the relative positions, an adjustment angle desired for the controllable light source or the flower pot where the plant grows; and rotating the controllable light source or the flower pot according to the adjustment angle.

Thus, according to the plant growth control method 600 provided by the embodiments of the present disclosure, growth information of a plant is acquired. A target irradiation position of the plant for a controllable light source to irradiate is determined according to the growth information. The controllable light source is controlled to irradiate the target irradiation position of the plant. The plant growth control method 600 solves the problem in the related art that a user needs to rotate the flower pot where the plant grows from time to time; and can automatically control the controllable light source to irradiate a portion of the plant that needs light irradiation, thereby reducing user's actions.

In some embodiments, each of the plant growth control methods 400, 500, and 600 may further include the following steps.

In step 701, a human body infrared signal in an environment is detected by using an infrared sensor.

In step 702, when the human body infrared signal is detected, the luminance of the controllable light source may be adjusted, or the controllable light source is controlled to blink, or the pot where the plant grows is controlled to rotate, or any combination thereof may be performed.

When a person approaches a plant, the human body infrared sensor in the plant growth control system may detect a human body infrared signal. The processor may increase the luminance of the light source, or control the light source to blink, or control the base of the flower pot to rotate, or a combination of the above actions, which brings a particular visual experience to a user, and improves the user experience. In some embodiments, the controllable light source includes a plurality of light sources having different colors of light, to create a dazzling visual experience to the user.

In some embodiments, one or more steps of the above methods may be performed by a mobile terminal, such as a mobile phone. A user may remotely control growth of the plant by using his or her mobile terminal, thereby improving the user experience.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

What is claimed is:

1. A plant growth control system, comprising: an information collection device, a processor coupled to the information collection device, and a controllable light source; wherein:
the information collection device is configured to acquire growth information of a plant, the growth information including at least one of branch and leaf distribution information of the plant or flower distribution information of the plant; and
the processor is configured to determine, according to the growth information, a target irradiation position of the plant for the controllable light source to irradiate, and control the controllable light source to irradiate the target irradiation position of the plant.

2. The system according to claim 1, wherein the information collection device comprises a plurality of light intensity sensors; and wherein:
the light intensity sensors are configured to acquire light intensities yielded after ambient light penetrates through the plant; and
the processor is further configured to determine the growth information of the plant according to the light intensities acquired by the light intensity sensors.

3. The system according to claim 2, wherein the system further comprises a flower pot, wherein the light intensity sensors are arranged on an edge of the flower pot.

4. The system according to claim 1, wherein the information collection device comprises a camera; and wherein:
the camera is configured to acquire an image containing the plant; and
the processor is further configured to acquire the growth information of the plant according to the image.

5. The system according to claim 1, wherein the controllable light source is in a moving state or a stationary state under control of the processor.

6. The system according to claim 1, further comprising a base for accommodating the flower pot, wherein the base is in a rotation state or a stationary state under control of the processor.

7. The system according to claim 1, further comprising an infrared sensor, wherein:
the infrared sensor is configured to detect a human body infrared signal in an environment; and
the processor is further configured to, when the infrared sensor detects the human body infrared signal, (1) adjust luminance of the controllable light source, or (2) control the controllable light source to blink, or (3) rotate a flower pot where the plant grows, or (4) perform a combination of at least two of (1), (2), or (3).

8. A plant growth control method, the method being performed in a plant growth control system which comprises an information collection device, a processor coupled to the information collection device, and a controllable light source, wherein the method comprises:
acquiring growth information of a plant, the growth information including at least one of branch and leaf distribution information of the plant or flower distribution information of the plant;
determining, according to the growth information, a target irradiation position of the plant; and
controlling the controllable light source to irradiate the target irradiation position of the plant.

9. The method according to claim 8, wherein acquiring growth information of the plant comprises:
acquiring, by using a plurality of light intensity sensors arranged at the bottom of the plant, light intensities yielded after ambient light penetrates through the plant; and
determining the growth information of the plant according to the acquired light intensities.

10. The method according to claim 9, wherein controlling the controllable light source to irradiate the target irradiation position of the plant comprises one of:
controlling the controllable light source in an ON state to rotate, and stopping the rotation of the controllable light source when a light intensity sensor corresponding to the target irradiation position acquires a light intensity greater than a predetermined light intensity; or
controlling the controllable light source in an ON state to move, and stopping the movement of the controllable light source when the light intensity sensor corresponding to the target irradiation position acquires a light intensity greater than the predetermined light intensity; or
controlling a flower pot where the plant grows to rotate, and stopping the rotation of the flower pot when the light intensity sensor corresponding to the target irradiation position acquires a light intensity greater than the predetermined light intensity.

11. The method according to claim 8, wherein acquiring growth information of a plant comprises:
acquiring, by using a camera, an image containing the plant; and
acquiring the growth information of the plant according to the image.

12. The method according to claim 11, wherein the image further contains the controllable light source, and controlling the controllable light source to irradiate the target irradiation position of the plant comprises:
determining positions of the controllable light source and the target irradiation position relative to each other according to the image;
determining, according to the relative positions, an adjustment angle for one of the controllable light source or the flower pot where the plant grows; and
rotating the one of the controllable light source or the flower pot according to the adjustment angle.

13. The method according to claim 8, wherein determining, according to the growth information, a target irradiation position of the plant comprises:
when the growth information includes the branch and leaf distribution information, determining a side of the plant where a sparse degree of a branch and leaf distribution is less than a first threshold as the target irradiation position, or determining a side of the plant where a sparse degree of the branch and leaf distribution is greater than a second threshold as the target irradiation position; and
when the growth information includes the flower distribution information, determining a side of the plant where flowers are blooming as the target irradiation position.

14. The method according to claim 8, further comprising:
detecting, by using an infrared sensor, a human body infrared signal in an environment; and
when the human body infrared signal is detected, (1) adjusting luminance of the controllable light source, or (2) controlling the controllable light source to blink, or (3) rotating a flower pot where the plant grows, or (4) performing a combination of at least two of (1), (2), or (3).
